(19) United States
(12) Patent Application Publication
(10) Pub. No.: US 2025/0314505 A1
(43) Pub. Date: Oct. 9, 2025

(54) DETECTION OF STRAIGHT DRIVING FOR MOTION ESTIMATION AND SENSING ALIGNMENT

(71) Applicant: GM Global Technology Operations LLC, Detroit, MI (US)

(72) Inventors: Ami Woo, Calgary (CA); Mohammadali Shahriari, Markham (CA); Dhaval Kavindra Sompura, Canton, MI (US); Erick Mauricio Via Lopez, Ann Arbor, MI (US); Jin-Jae Chen, Canton, MI (US)

(21) Appl. No.: 18/630,598

(22) Filed: Apr. 9, 2024

(51) Int. Cl. G01C 25/00; G01C 21/28

(52) U.S. Cl. CPC G01C 25/00; G01C 21/28

(57) ABSTRACT

A vehicle includes a system for calibrating a sensor of the vehicle moving on a road section. The processor determines a control condition variable indicative of a trajectory of the vehicle with respect to a straight line, determines a bank angle condition variable indicative of a motion of the vehicle with respect to the straight line based on a bank angle of the road section, determines a torque condition variable indicative of the motion of the vehicle with respect to the straight line based on a torque applied to a steering wheel of the vehicle, determines a straight-line condition for the vehicle when at least one of the control condition variable, the bank angle condition variable and the torque condition variable indicates that the vehicle is moving in the straight line, and calibrates the sensor when the vehicle is in the straight-line condition.

### INTRODUCTION

The subject disclosure relates to an operation for aligning a sensor of a vehicle and, in particular, to a system and method for determining a straight line driving condition suitable for sensor alignment.

In order to facilitate driving and maneuvering, a vehicle can employ one or more sensors for detecting its environment. For correct operation of the vehicle, a sensor will need to be aligned with the vehicle and calibrated to account for any associated sensor bias. Sensor bias can be corrected while the vehicle is in motion, as long as the vehicle is moving in a straight line. Accordingly, it is desirable to provide a method for determining when the vehicle is driving in a straight line for sensor alignment.

### SUMMARY

In one exemplary embodiment, a method for calibrating a sensor of a vehicle moving on a road section is disclosed. A control condition variable indicative of a trajectory of the vehicle with respect to a straight line is determined. A bank angle condition variable indicative of a motion of the vehicle with respect to the straight line based on a bank angle of the road section is determined. A torque condition variable indicative of the motion of the vehicle with respect to the straight line based on a torque applied to a steering wheel of the vehicle is determined. A straight-line condition for the vehicle is determined when at least one of the control condition variable, the bank angle condition variable and the torque condition variable indicates that the vehicle is moving in the straight line. The sensor is calibrated when the vehicle is in the straight-line condition.

In addition to one or more of the features described herein, the bank angle condition variable is determined based on at least one of map server data, a vehicle dynamics, and Global Positioning Satellite (GPS) data.

In addition to one or more of the features described herein, the method further includes determining a pending driving straight condition variable based on at least one of a heading condition variable based on Global Positioning Satellite (GPS) heading data, a derived heading condition variable based on a latitude and a longitude of the vehicle obtained from GPS, a wheel velocity condition variable based on differences in wheel velocities, and a road curvature condition variable.

In addition to one or more of the features described herein, the wheel velocity condition variable is based on a difference between at least one of a right front wheel velocity and a left front wheel velocity, a right rear wheel velocity and a left rear wheel velocity, the right front wheel velocity and the left rear wheel velocity, and the left front wheel velocity and the right rear wheel velocity.

In addition to one or more of the features described herein, the road curvature condition variable is based on at least one of a left-side image obtained from a left-side camera of the vehicle, a right-side image obtained from a right-side camera of the vehicle, and a meaning of a road sign in at least one of the left-side image and the right-side image.

In addition to one or more of the features described herein, the method further includes obtaining a plurality of the pending driving straight condition variables over a time window and determining a matured straight driving condition variable from the plurality of pending driving straight condition variables.

In addition to one or more of the features described herein, the method further includes learning a bias correction for the sensor using the matured driving straight condition.

In addition to one or more of the features described herein, the control condition variable is based on a commanded trajectory of the vehicle and an error between the commanded trajectory and the straight line.

In another exemplary embodiment, a system for calibrating a sensor of a vehicle is disclosed. The system includes a processor configured to determine a control condition variable indicative of a trajectory of the vehicle with respect to a straight line, determine a bank angle condition variable indicative of a motion of the vehicle with respect to the straight line based on a bank angle of a road section, determine a torque condition variable indicative of the motion of the vehicle with respect to the straight line based on a torque applied to a steering wheel of the vehicle, determine a straight-line condition for the vehicle when at least one of the control condition variable, the bank angle condition variable and the torque condition variable indicates that the vehicle is moving in the straight line, and calibrate the sensor when the vehicle is in the straight-line condition.

In addition to one or more of the features described herein, the processor is further configured to determine the bank angle condition variable based on at least one of map server data, a vehicle dynamics, and Global Positioning Satellite (GPS) data.

In addition to one or more of the features described herein, the processor is further configured to determine a pending driving straight condition variable based on at least one of a heading condition variable based on Global Positioning Satellite (GPS) heading data, a derived heading condition variable based on a latitude and a longitude of the vehicle obtained from GPS, a wheel velocity condition variable based on differences in wheel velocities, and a road curvature condition variable.

In addition to one or more of the features described herein, the wheel velocity condition variable is based on a difference between at least one of a right front wheel velocity and a left front wheel velocity, a right rear wheel velocity and a left rear wheel velocity, the right front wheel velocity and the left rear wheel velocity, and the left front wheel velocity and the right rear wheel velocity.

In addition to one or more of the features described herein, the road curvature condition variable is based on at least one of a left-side image obtained from a left-side camera of the vehicle, a right-side image obtained from a right-side camera of the vehicle, and a meaning of a road sign in at least one of the left-side image and the right-side image.

In addition to one or more of the features described herein, the processor is further configured to obtain a plurality of the pending driving straight condition variables over a time window and determine a matured straight driving condition variable from the plurality of pending driving straight condition variables.

In addition to one or more of the features described herein, the control condition variable is based on a commanded trajectory of the vehicle and an error between the commanded trajectory and the straight line.

In another exemplary embodiment, a vehicle is disclosed. The vehicle includes a sensor and a processor. The processor is configured to determine a control condition variable indicative of a trajectory of the vehicle with respect to a straight line, determine a bank angle condition variable indicative of a motion of the vehicle with respect to the straight line based on a bank angle of a road section, determine a torque condition variable indicative of the motion of the vehicle with respect to the straight line based on a torque applied to a steering wheel of the vehicle, determine a straight-line condition for the vehicle when at least one of the control condition variable, the bank angle condition variable and the torque condition variable indicates that the vehicle is moving in the straight line, and calibrate the sensor when the vehicle is in the straight-line condition.

In addition to one or more of the features described herein, the processor is further configured to determine the bank angle condition variable based on at least one of map server data, a vehicle dynamics, and Global Positioning Satellite (GPS) data.

In addition to one or more of the features described herein, the processor is further configured to determine a pending driving straight condition variable based on at least one of a heading condition variable based on Global Positioning Satellite (GPS) heading data, a derived heading condition variable based on a latitude and a longitude of the vehicle obtained from GPS, a wheel velocity condition variable based on differences in wheel velocities, and a road curvature condition variable.

In addition to one or more of the features described herein, the wheel velocity condition variable is based on a difference between at least one of a right front wheel velocity and a left front wheel velocity, a right rear wheel velocity and a left rear wheel velocity, the right front wheel velocity and the left rear wheel velocity, and the left front wheel velocity and the right rear wheel velocity.

In addition to one or more of the features described herein, the road curvature condition variable is based on at least one of a left-side image obtained from a left-side camera of the vehicle, a right-side image obtained from a right-side camera of the vehicle, and a meaning of a road sign in at least one of the left-side image and the right-side image.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system, in an illustrative embodiment;

FIG. 2 shows a flowchart of a process for generating a heading condition variable and derived heading condition variable;

FIG. 3 shows a flowchart of a process for determining a straight heading condition variable for the vehicle based on the velocities of the wheels of the vehicle;

FIG. 4 shows flowchart of process for determining driving straight condition variables based on a curvature of the road and on a bank angle of the road;

FIG. 5 is a flowchart of a process for determining a command heading variable;

FIG. 6 shows a flowchart for determining a yaw rate condition variable;

FIG. 7 shows a flowchart for determining a road wheel angle condition variable and a driver torque condition variable;

FIG. 8 shows a diagram for determining a straight line condition for the vehicle; and

FIG. 9 is a flowchart for a maturation process for the pending driving straight condition variable.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

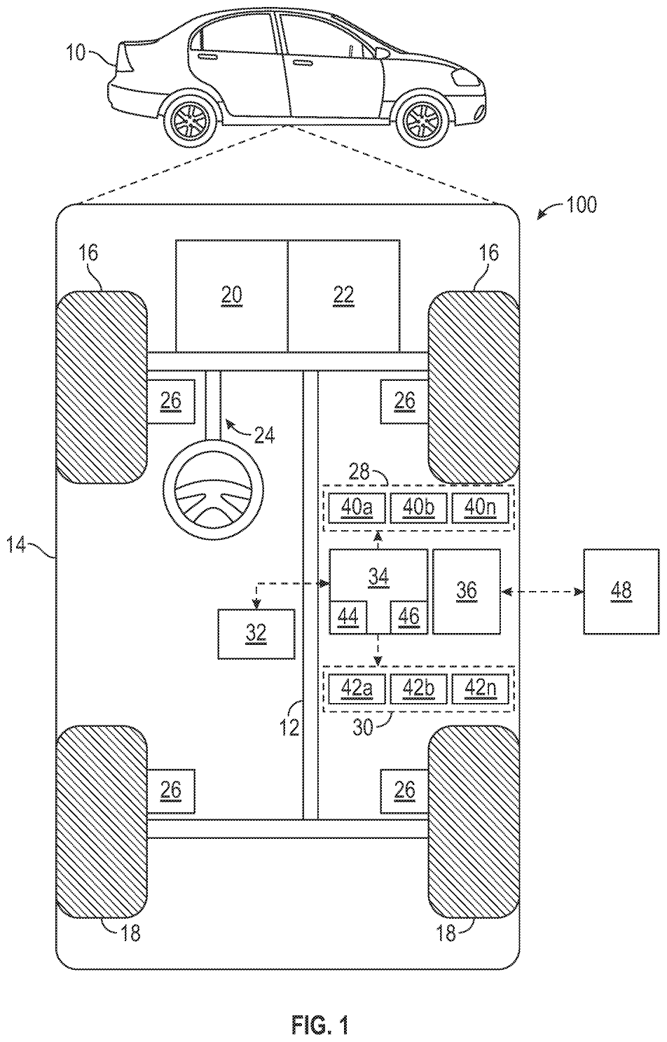

In accordance with an exemplary embodiment, FIG. 1 shows a vehicle 10 with an associated trajectory planning system depicted at 100. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the trajectory planning system 100 is incorporated into the autonomous vehicle. The autonomous vehicle is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensor system 28 can also include dynamic sensors for measuring one or more dynamic parameters of the vehicle. Exemplary dynamic sensors include an inertial measurement unit (IMU) that measures accelerations at the vehicle in three dimensions, a steering angle sensor, a torque sensor, a yaw rate sensor, a wheel velocity sensor, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air conditioning, music, lighting, etc. (not shown).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the trajectory planning system 100 and, when executed by the processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The communication system 36 is configured to wirelessly communicate information to and from other entities 48, such as but not limited to, other vehicles (“V2V” communication,) infrastructure (“V2I” communication), remote systems, Global Positioning Satellite (GPS), map servers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

On occasion, sensors of the sensor system 28 require calibration to adjust for sensor bias. This calibration can be performed while the vehicle is moving in a straight line. Methods disclosed herein therefore determine whether the vehicle is moving in a straight line or is deviating from straight-line motion. The method includes obtaining data from various sources, including Global Positioning Satellite (GPS) data, vehicle sensors, control commands, etc., and performing calculations on this data. Calculations can be performed to produce one or more variables, each of which provides an indication of whether the vehicle is moving in a straight line. Logical operations can be performed on each of the variables to determine a straight-line condition (i.e., that the vehicle is moving in a straight line).

The various data can be from difference domains. One data domain includes data from a trajectory planner or other commanded data. Another data domain includes data concerning the environment of the vehicle, such as data about the road conditions. Another data domain includes vehicle dynamics, such as data indicative of a heading of the vehicle and wheel velocities.

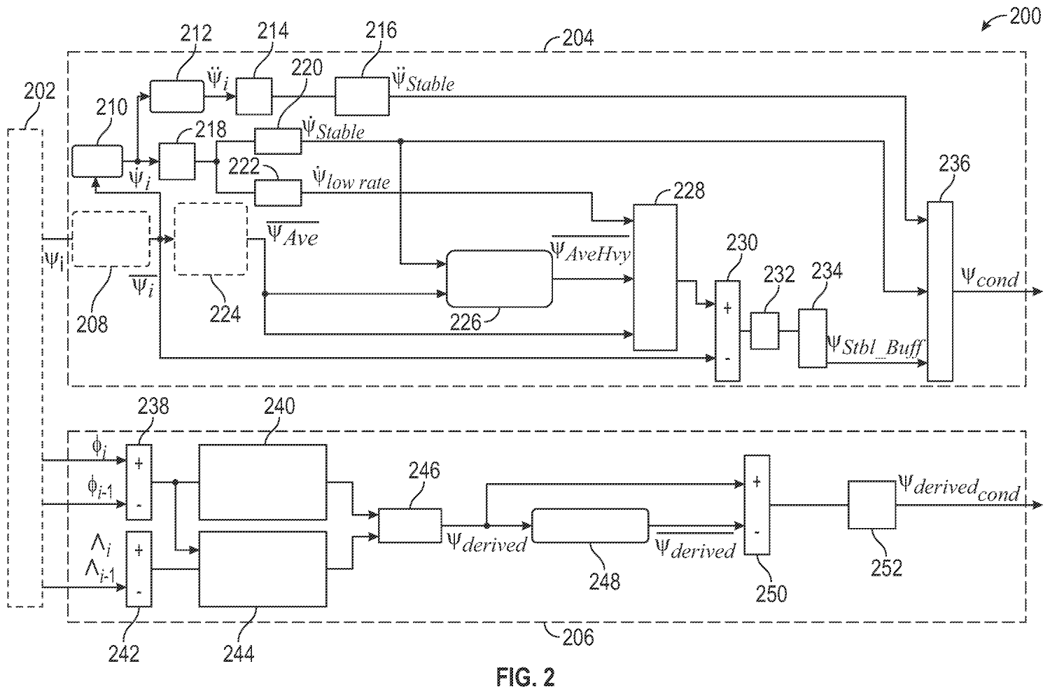

FIG. 2 shows a flowchart 200 of a process for generating a heading condition variable and derived heading condition variable. The logical process can be performed at processor 44 of the vehicle. In box 202, GPS data is received that indicates a location of the vehicle. The data includes at least one of a heading ψ of the vehicle (indicating an orientation of the vehicle within an earth-centered coordinate system), a latitude Φ of the vehicle, and a longitude Λ of the vehicle. The heading ψ is used in a first channel 204 to determine a value of the heading condition variable. The latitude Φ and longitude Λ are used in a second channel 206 to determine a value of the derived heading condition variable. Data is received over a time duration defined by a time window.

Referring first to the first channel 204, in box 208, the heading data \dot{ψ}ᵢ (over n time steps) is sent through a stochastic filter that outputs a filtered heading ψ̅ᵢ. The filtered heading is sent to boxes 210, 224 and 230. In box 210, a first derivative of the heading data ψᵢ is obtained to generate a heading rate \dot{ψ}ᵢ. The heading rate \dot{ψ}ᵢ is sent to box 212 in which a second derivative is obtained to generate a heading acceleration \ddot{ψ}ᵢ. In box 214, an absolute value |\ddot{ψ}ᵢ| of the heading acceleration \ddot{ψ}ᵢ is calculated. In box 216, the absolute value |\ddot{ψ}ᵢ| is compared to a heading acceleration threshold C1. A heading acceleration stability variable \ddot{ψ}_{stable} is generated based on the comparison. If the absolute value is less than the heading acceleration threshold C1, the heading acceleration stability variable \ddot{ψ}_{stable} is set to TRUE. Otherwise, the heading acceleration stability variable \ddot{ψ}_{stable} is set to FALSE.

Returning to box 210, the first derivative of the heading rate \dot{ψ}ᵢ is sent to box 218. In box 218, an absolute value |\dot{ψ}ᵢ| of the first derivative of the heading rate \dot{ψ}ᵢ is calculated. In box 220, the absolute value |\dot{ψ}ᵢ| is compared to a first derivative threshold C2. A first derivative stability variable \dot{ψ}_{stable} is generated based on the comparison. If the absolute value |\dot{ψ}ᵢ| is less than the first derivative threshold C2, the first derivative stability variable \dot{ψ}_{stable} is set to TRUE. Otherwise, it is set to FALSE.

Returning to box 218, the absolute value |\dot{ψ}ᵢ| is also sent to box 222. In box 222, the absolute value |\dot{ψ}ᵢ| is compared to a low first derivative threshold C3. A low first derivative stability variable \dot{ψ}_{stable} is generated based on the comparison. If the absolute value |\dot{ψ}ᵢ| is less than the low first derivative threshold C3, the low first derivative stability variable \dot{ψ}_{stable} is set to TRUE. Otherwise, it is set to FALSE.

Returning to box 208, the filtered heading ψ̅ᵢ̅ is sent to box 224. In box 224, a stable signal detection is performed which outputs a moving average of the heading ψ̅ₐ̅ᵥ̅ₑ̅ over a time period.

The moving average heading ψ̅ₐ̅ᵥ̅ₑ̅ is sent from box 224 to box 226. Also, the first derivative stability variable \dot{ψ}_{stable} is sent from box 220 to the box 226. In box 226 a stochastic filter is performed on the moving average heading ψ̅ₐ̅ᵥ̅ₑ̅ and enabled by the first derivative stability variable \dot{ψ}_{stable} to generate the moving average heavily filtered heading ψ̅_̅{̅a̅v̅e̅H̅v̅y̅}̅. In box 228, a selection is made based on the low rate first derivative stability variable \dot{ψ}_{low_rate}. If the low rate first derivative stability variable \dot{ψ}_{low_rate} indicates that the first derivative of the heading is less than the threshold C3, the value of ψ̅_̅{̅a̅v̅e̅H̅v̅y̅}̅ is forwarded to box 230. Otherwise, the average heading ψ̅ₐ̅ᵥ̅ₑ̅ is forwarded to the box 230. In box 230, a difference is calculated between the output of box 228 (either ψ̅_̅{̅a̅v̅e̅H̅v̅y̅}̅ or ψ̅ₐ̅ᵥ̅ₑ̅) and the filtered heading ψ̅ᵢ̅ (from box 208). In box 232, an absolute value of the difference is generated. In box 234, the absolute value is compared to a calibration value and a buffed stability condition variable is generated. ψ_{Stbl_Buff}. If the absolute value is less than the calibration value, the value of ψ_{Stbl_Buff} is TRUE. Otherwise, it is FALSE.

At box 236, a logical AND operation is performed between the heading acceleration stability variable \ddot{ψ}_{stable} (from box 216), the first derivative stability condition variable \dot{ψ}_{stable}, and the buffed stability condition variable ψ_{Stbl_Buff} to generate a value for the heading condition variable ψ_{cond}.

Referring now to the second channel 206, in box 238, a latitude difference ΔΦ is determined between a current latitude value Φᵢ and a previous latitude value Φᵢ₋₁. In box 240 an earth-based differential vertical coordinate dy is calculated, as shown in Eq. (1):

$$d y = R ( Δ Φ ) \qquad Eq . ( 1 )$$

where R is an average radius of the Earth where ΔΦ=Φᵢ−Φᵢ₋₁. In box 242, a longitude difference ΔΛ is determined between a current longitude value Λᵢ to a previous longitude value Λᵢ₋₁. In box 244, an earth-based differential horizontal coordinate dx is calculated, as shown in Eq. (2):

$$d x = R ( Δ Λ ) cos ( Δ Φ ) \qquad Eq . ( 2 )$$

where ΔΛ=Λᵢ−Λᵢ₋₁. In box 246, a derived heading ψ_{derived} is calculated using the earth-based differential latitude of Eq. (1) and the earth-based differential longitude of Eq. (2), as shown in Eq. (3):

$${ψ}_{d e r i v e d} = {tan}^{- 1} \frac{d x}{d y} \qquad Eq . ( 3 )$$

In box 248, the derived heading ψ_{derived} is input to a stochastic filter which outputs a moving average ψ̅_̅{̅d̅e̅r̅i̅v̅e̅d̅}̅ of the derived heading. In box 250, a difference is calculated between the derived heading ψ_{derived} and the moving average ψ̅_̅{̅d̅e̅r̅i̅v̅e̅d̅}̅ of the derived heading. In box 252, the difference is compared to a threshold to generate a derived heading condition variable ψ_{derived}_{_{cond}}. If the difference is less than the threshold C5, the derived heading condition variable ψ_{derived}_{_{cond}} is set to TRUE. Otherwise, the derived heading condition variable ψ_{derived}_{_{cond}} is set to FALSE.

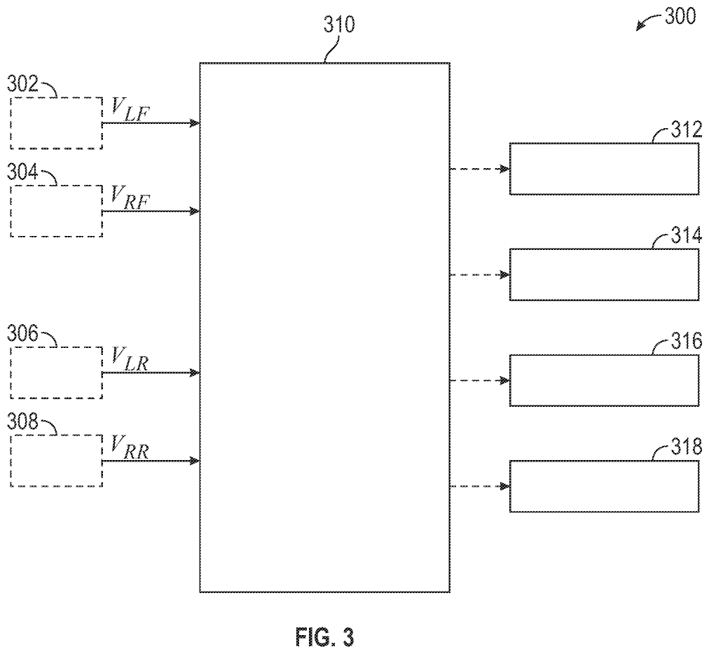

FIG. 3 shows a flowchart 300 of a process for determining a straight heading condition variable for the vehicle based on the velocities of the wheels of the vehicle. A left front wheel sensor 302 provides a left front wheel velocity ν_{LF}, a right front wheel sensor 304 provides a right front wheel velocity ν_{RF}, a left rear wheel sensor 306 provides a left rear wheel velocity ν_{LR}, and a right rear wheel sensor 308 provides and a right rear wheel velocity ν_{RR}. A wheel velocity difference module 310 compares differences between front wheel velocities to a calibration value and a front wheel velocity condition variable 312 (FrontWheel_{cond}) is calculated. If abs(ν_{LF}−ν_{RF})<C, then FrontWheel_{cond}=TRUE. Otherwise FrontWheel_{cond}=FALSE.

Similarly, the wheel velocity difference module 310 compares a difference between left rear wheel velocity ν_{LR} and the right rear wheel velocity ν_{RR} is compared to a constant value and outputs a rear wheel velocity condition variable 314 (RearWheel_{cond}). If abs (ν_{LR}−ν_{RR})<C, then RearWheel_{cond}=TRUE. Otherwise RearWheel_{cond}=FALSE.

The wheel velocity difference module 310 also monitors diagonal wheel velocities. The right front wheel velocity ν_{RF} is compared to the left rear wheel velocity ν_{LR} to output a first cross wheel velocity condition variable 316 (CrossWheel1_{cond}). If abs (ν_{RF}−ν_{LR})<C, then CrossWheel1_{cond}=TRUE. Otherwise CrossWheel1_{cond}=FALSE. The left front wheel velocity ν_{LF} is compared to the right rear wheel velocity ν_{RR} to output a second cross wheel velocity condition variable 318 (CrossWheel2_{cond}). If abs (ν_{LF}−ν_{RR})<C, then CrossWheel2_{cond}=TRUE. Otherwise CrossWheel2_{cond}=FALSE.

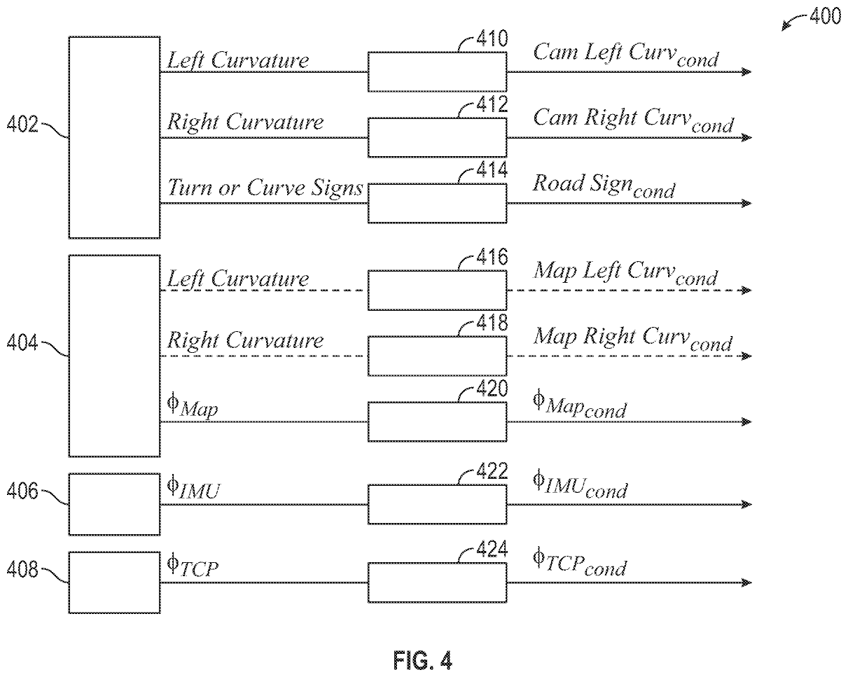

FIG. 4 shows flowchart 400 of process for determining driving straight condition variables based on a curvature of the road and on a bank angle of the road. The data used to make these calculations are environmental variables received from various sources, such as one or more cameras on the vehicle (box 402), a map server (box 404), an internal measurement unit (IMU) (box 406) that measures acceleration, and a GPS system (box 408). In box 402, the one or more cameras produce images of the road. A left-side camera obtains an image of the road from the left side of the vehicle and a right-side camera obtains an image of the road from the right side of the vehicle. Either of these images, as well as images from other cameras of the vehicle, can be processed to locate road signs and decipher the meanings of the road signs. A curvature of the road towards the left (“left curvature”) can be determined from the left-side image. A curvature of the road toward the right (“right curvature”) can be determined from the right-side image. In box 410, the left curvature is compared to a threshold C_{LC} value to generate a left camera curvature condition variable (CamLeftCurve_{cond}). If the left curvature is greater than the threshold value C_{LC}, then CamLeftCurV_{cond}=TRUE. Otherwise, CamLeftCurv_{cond}=FALSE.

In box 412, the right curvature is compared to a threshold value C_{RC} to generate a right camera curvature condition variable (CamRightCurve_{cond}). If the right curvature is greater than the threshold value C_{RC}, then CamRightCurv_{cond}=TRUE. Otherwise, CamRightCurv_{cond}=FALSE.

In box 414, the road sign is interpreted to determine whether the road sign indicates a curved road and thereby set a road sign condition variable RoadSign_{cond}. If there is an indication of a curved road is determined from the road sign, the RoadSign_{cond}=TRUE. Otherwise RoadSign_{cond}=FALSE.

In box 404, curvature is determined from map data obtained from a map server. The curvature includes a map-based left curvature, a map-based right curvature and a map-based bank angle ϕ_{Map}. In box 416, the map-based left curvature is compared to a threshold C_{LC}, thereby generating a left map-based camera curvature condition variable (MapLeftCurve_{cond}). If the map-based left curvature is greater than the threshold C_{LC}, then MapLeftCurv_{cond}=TRUE. Otherwise, MapLeftCurv_{cond}=FALSE.

In box 418, the map-based right curvature is compared to a threshold C_{RC}, thereby generating a map-based right camera curvature condition variable (MapRightCurve_{cond}). If the map-based right curvature is greater than the threshold C_{RC}, then MapRightCurv_{cond}=TRUE. Otherwise, MapRightCurv_{cond}=FALSE.

In box 420, the map-based bank angle ϕ_{Map} is compared to a bank angle threshold C_{ϕ} to generate a map-based bank angle condition variable (ϕ_{Map}_{_{cond}}). If the map-based bank angle curvature is greater than the bank angle threshold C_{ϕ}, then ϕ_{Map}_{_{cond}}=TRUE. Otherwise, ϕ_{Map}_{_{cond}}=FALSE.

In box 406, an IMU generates an IMU bank angle ϕ_{IMU}. In box 422, the IMU bank angle ϕ_{IMU} is compared to a bank angle threshold C_{ϕ} to generate an IMU bank angle condition variable (ϕ_{IMU}_{_{cond}}). If the IMU bank angle curvature is greater than the IMU bank angle threshold C_{ϕ}, then ϕ_{IMU}_{_{cond}}=TRUE. Otherwise, ϕ_{IMU}_{_{cond}}=FALSE.

In box 408, GPS data is used to provides a TCP bank angle ϕ_{TCP}. In box 424, the TCP bank angle ϕ_{TCP} is compared to a bank angle threshold C_{ϕ} to generate a TCP bank angle condition variable (ϕ_{TCP}_{_{cond}}). If the TCP bank angle curvature is less than the TCP bank angle threshold C_{ϕ}, then ϕ_{TCP}_{_{cond}}=TRUE. Otherwise, ϕ_{TCP}_{_{cond}}=FALSE.

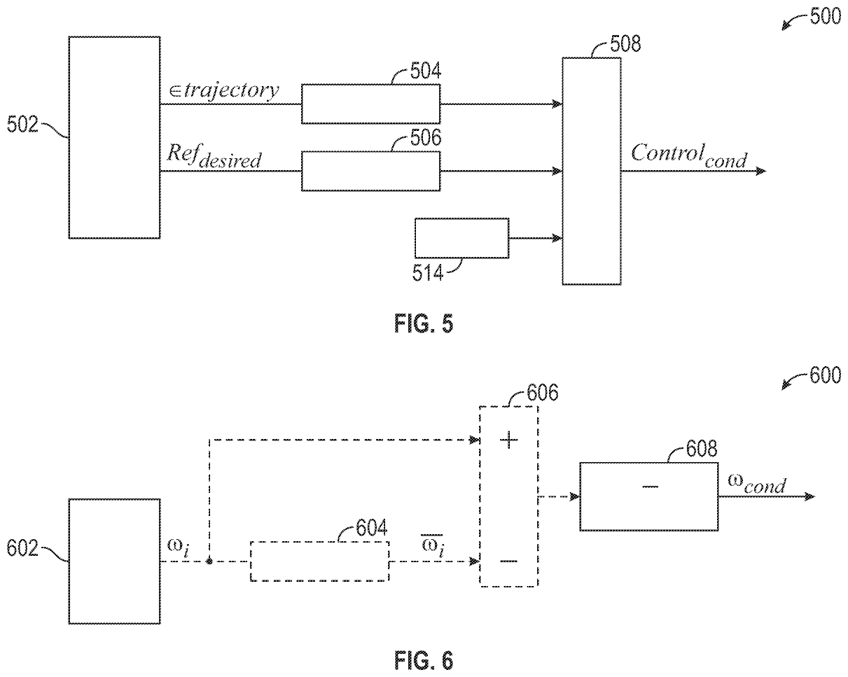

FIG. 5 is a flowchart 500 of a process for determining a command heading variable. In box 502, a trajectory planner of the vehicle outputs a commanded trajectory (Ref_{desired}) and a trajectory error ε_{trajectory}. The trajectory error is a difference between the commanded trajectory and vehicle trajectory. In box 504, the trajectory error is compared to an error calibration constant C_{ε} to generate an error condition variable. In box 506, the commanded trajectory is reviewed to determine if the trajectory to follow is curved. If the trajectory to follow is curved, the trajectory condition variable is FALSE. Otherwise, the trajectory condition variable is TRUE. In box 508, the error condition variable and the trajectory condition variable are used to determine a value of a control condition variable Control_{cond}. If the error condition variable indicates that there is not much deviation between the desired trajectory and vehicle's trajectory, then the Control_{cond} takes the trajectory condition. Otherwise, the Control_{cond} is set to FALSE.

FIG. 6 shows a flowchart 600 for determining a yaw rate condition variable. The yaw rate is a dynamic parameters determined from sensors at the vehicle, such as the IMU. In box 602, the yaw rate ωᵢ is generated. In box 604, a stochastic filter is applied to the yaw rate ωᵢ to generate and a moving average yaw rate ω̅ᵢ̅. In box 606, a difference is calculated between the yaw rate di and the moving average yaw rate ω̅ᵢ̅. In box 608, the difference is compared to a threshold value to generate a yaw rate condition variable ω_{cond}. If the difference is less than the threshold value, then ω_{cond}=TRUE. Otherwise, ω_{cond}=FALSE.

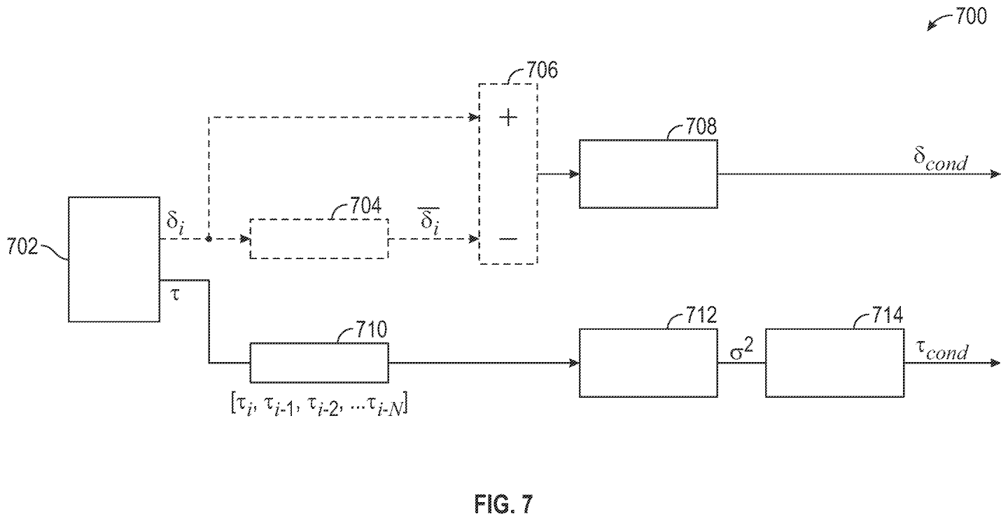

FIG. 7 shows a flowchart 700 for determining a road wheel angle condition variable and a driver torque condition variable. In box 702, power steering of the vehicle generates a road wheel angle δᵢ. In box 704, a stochastic filter is applied to the road wheel angle δᵢ to generate a moving average road wheel angle δ̅ᵢ̅. In box 706, a difference is calculated between the road wheel angle di and the moving average road wheel angle δ̅ᵢ̅. In box 708, the difference is compared to a threshold to generate the road wheel angle condition variable is δ_{cond}. If the difference is less than the threshold, then δ_{cond}=TRUE. Otherwise, δ_{cond}=FALSE.

In box 710, a time sequence of steering torques is read from a buffer. In box 712, a variance σ² of the steering torque is determined for the time sequence. In box 714, the variance σ² is compared to a threshold to generate a torque condition variable τ_{cond}. If the variance σ² is less than the threshold, then τ_{cond}=TRUE. Otherwise, τ_{cond}=FALSE.

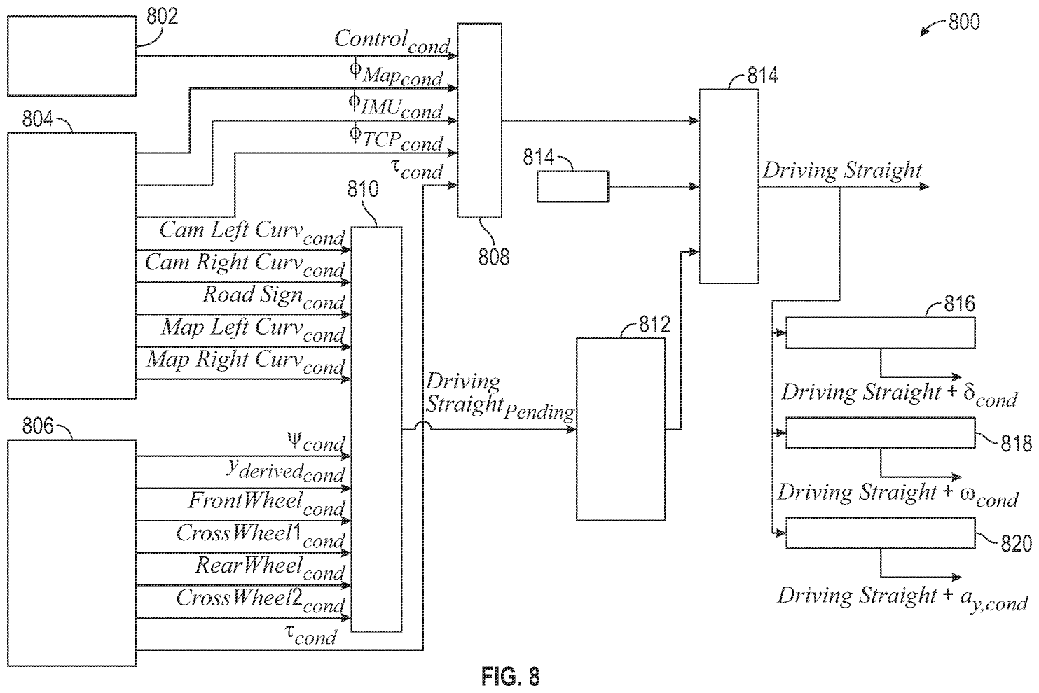

FIG. 8 shows a diagram 800 for determining a straight line condition for the vehicle. The flowchart includes processing the condition variable discussed herein with respect to FIGS. 2-7. The process includes receiving the condition variables from three domains: command parameters, environmental parameters and dynamic parameters. In box 802, the control parameters generate the command condition variable Control_{cond}. In box 804, the environmental parameters generate environmental condition variables (e.g., ϕ_{Map}_{_{cond}}, ϕ_{IMU}_{_{cond}}, ϕ_{TCP}_{_{cond}}, CamLeftCurve_{cond}, CamRightCurve_{cond}, RoadSign_{cond}, MapLeftCurve_{cond}, MapRightCurve_{cond}). In box 806, the vehicle dynamics parameters generate vehicle dynamic condition variables (ψ_{cond}, ψ_{derived}_{_{cond}}, FrontWheel_{cond}, CrossWheel1_{cond}, RearWheel_{cond}, CrossWheel2_{cond}, τ_{cond}).

In box 808, the Control_{cond}, ϕ_{Map}_{_{cond}}, ϕ_{IMU}_{_{cond}}, ϕ_{TCP}_{_{cond}}, τ_{cond} are sent through an OR gate. The OR gate provides an indication of a straight condition when any of these parameter indicate not the straight line condition.

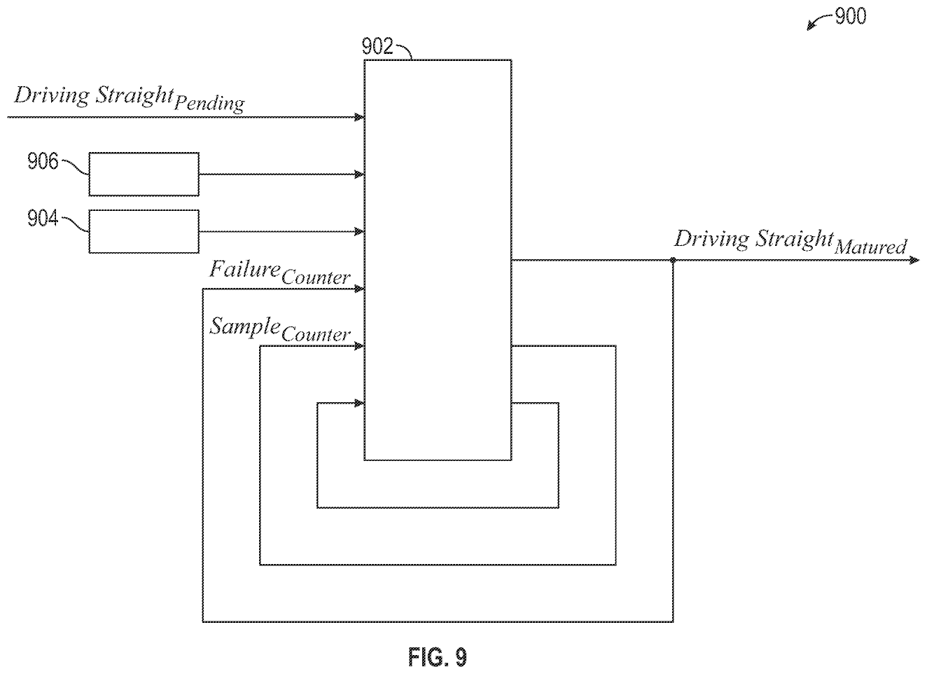

In box 810, the CamLeftCurve_{cond}, CamRightCurve_{cond}, RoadSign_{cond}, MapLeftCurve_{cond}, MapRightCurve_{cond}, ψ_{cond}, ψ_{derived}_{_{cond}}, FrontWheel_{cond}, CrossWheel1_{cond}, RearWheel_{cond}, and CrossWheel2_{cond} are sent to an AND gate. The AND gate outputs a DrivingStraight_{pending} variable which indicates an evaluation of the straight line condition based on these variables. Due to the use of an AND gate, all of these parameters need to indicate TRUE in order to the DrivingStraight_{pending} variable to be TRUE. In box 812, the DrivingStraight_{pending} variable is sent through a maturation process to generate a DrivingStraightₘₐₜᵤᵣₑ variable. The maturation process is discussed with respect to FIG. 9. In box 814, the outputs of box 808 and box 812 are revied to determine a straight-line condition for the vehicle. If any of the variables evaluated in box 808 indicate that the vehicle is not moving in a straight line, then DrivingStraight is set equal to FALSE. If not, then the results of box 812 are used to indicate when the vehicle is moving in a straight line. If the vehicle fails from the output of box 808 and from the output of box 812, then the DrivingStraight variable is assigned the value of FALSE.

Once the vehicle is in the straight-line condition, the sensors of the vehicle can be adjusted and/or calibrated. The bias correction(s) for the sensor(s) is then learned using the previous determination of the matured driving straight strategy. First, the steering angle sensors are adjusted (box 816) so that the straight-line condition variable is true and the road wheel angle variable is true (i.e., the vehicle is moving in a straight line and a variance of the road wheel angle sensed by the sensors is less than a criterion). Once the steering sensor is calibrated, the yaw rate sensors are adjusted (box 818). The yaw rate sensor is adjusted so that both the straight-line condition variable is true and the yaw rate condition variable is true (i.e., the vehicle is moving in a straight line and a variance of the road wheel angle sensed by the sensors is less than a criterion).

After the yaw rate sensor is calibrated, the lateral acceleration sensor is adjusted (box 820). The lateral acceleration sensor is adjusted so that both the straight-line condition variable is true and the lateral acceleration condition variable is true (i.e., the vehicle is moving in a straight line and a variance of the lateral acceleration sensed by the sensors is less than a criterion).

FIG. 9 is a flowchart 900 for a maturation process for the pending driving straight condition variable (DrivingStraight_{pending}). The maturation process involves calculations over samples within moving time window 902. The time window 902 is parameterized by a sample size 904 (Cₛₐₘₚₗₑ). The condition for maturation is parameterized by a failure condition parameter 906 (C_{failure}). The value of a DrivingStraight_{pending} variable is received and added to the sample. The number of failed values of the DrivingStraight_{pending} variables within the time window are counted to output the DrivingStraight_{matured} variable. If the number of failed values is less than C_{failure}, then DrivingStraight_{matured}=TRUE. Otherwise, DrivingStraight_{matured}=FALSE. A current count of the number of failures the number of samples are held for the next value of DrivingStraight_{pending} variable.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for calibrating a sensor of a vehicle moving on a road section, comprising:
determining a control condition variable indicative of a trajectory of the vehicle with respect to a straight line;
determining a bank angle condition variable indicative of a motion of the vehicle with respect to the straight line based on a bank angle of the road section;
determining a torque condition variable indicative of the motion of the vehicle with respect to the straight line based on a torque applied to a steering wheel of the vehicle;
determining a straight-line condition for the vehicle when at least one of the control condition variable, the bank angle condition variable and the torque condition variable indicates that the vehicle is moving in the straight line; and
calibrating the sensor when the vehicle is in the straight-line condition.

2. The method of claim 1, wherein the bank angle condition variable is determined based on at least one of: (i) map server data; (ii) a vehicle dynamics; and (iii) Global Positioning Satellite (GPS) data.

3. The method of claim 1, further comprising determining a pending driving straight condition variable based on at least one of: (i) a heading condition variable based on Global Positioning Satellite (GPS) heading data; (ii) a derived heading condition variable based on a latitude and a longitude of the vehicle obtained from GPS; (iii) a wheel velocity condition variable based on differences in wheel velocities; and (iv) a road curvature condition variable.

4. The method of claim 3, wherein the wheel velocity condition variable is based on a difference between at least one of: (i) a right front wheel velocity and a left front wheel velocity; (ii) a right rear wheel velocity and a left rear wheel velocity: (iii) the right front wheel velocity and the left rear wheel velocity; and (iv) the left front wheel velocity and the right rear wheel velocity.

5. The method of claim 3, wherein the road curvature condition variable is based on at least one of: (i) a left-side image obtained from a left-side camera of the vehicle; (ii) a right-side image obtained from a right-side camera of the vehicle; and (iii) a meaning of a road sign in at least one of the left-side image and the right-side image.

6. The method of claim 3, further comprising obtaining a plurality of the pending driving straight condition variables over a time window and determining a matured straight driving condition variable from the plurality of pending driving straight condition variables.

7. The method of claim 6, further comprising learning a bias correction for the sensor using the matured driving straight condition.

8. The method of claim 1, wherein the control condition variable is based on a commanded trajectory of the vehicle and an error between the commanded trajectory and the straight line.

9. A system for calibrating a sensor of a vehicle, comprising:
a processor configured to:
determine a control condition variable indicative of a trajectory of the vehicle with respect to a straight line;
determine a bank angle condition variable indicative of a motion of the vehicle with respect to the straight line based on a bank angle of a road section;
determine a torque condition variable indicative of the motion of the vehicle with respect to the straight line based on a torque applied to a steering wheel of the vehicle;
determine a straight-line condition for the vehicle when at least one of the control condition variable, the bank angle condition variable and the torque condition variable indicates that the vehicle is moving in the straight line; and
calibrate the sensor when the vehicle is in the straight-line condition.

10. The system of claim 9, wherein the processor is further configured to determine the bank angle condition variable based on at least one of: (i) map server data; (ii) a vehicle dynamics; and (iii) Global Positioning Satellite (GPS) data.

11. The system of claim 9, wherein the processor is further configured to determine a pending driving straight condition variable based on at least one of: (i) a heading condition variable based on Global Positioning Satellite (GPS) heading data; (ii) a derived heading condition variable based on a latitude and a longitude of the vehicle obtained from GPS; (iii) a wheel velocity condition variable based on differences in wheel velocities; and (iv) a road curvature condition variable.

12. The system of claim 11, wherein the wheel velocity condition variable is based on a difference between at least one of: (i) a right front wheel velocity and a left front wheel velocity; (ii) a right rear wheel velocity and a left rear wheel velocity: (iii) the right front wheel velocity and the left rear wheel velocity; and (iv) the left front wheel velocity and the right rear wheel velocity.

13. The system of claim 11, wherein the road curvature condition variable is based on at least one of: (i) a left-side image obtained from a left-side camera of the vehicle; (ii) a right-side image obtained from a right-side camera of the vehicle; and (iii) a meaning of a road sign in at least one of the left-side image and the right-side image.

14. The system of claim 11, wherein the processor is further configured to obtain a plurality of the pending driving straight condition variables over a time window and determine a matured straight driving condition variable from the plurality of pending driving straight condition variables.

15. The system of claim 9, wherein the control condition variable is based on a commanded trajectory of the vehicle and an error between the commanded trajectory and the straight line.

16. A vehicle, comprising:
a sensor; and
a processor configured to:
determine a control condition variable indicative of a trajectory of the vehicle with respect to a straight line;
determine a bank angle condition variable indicative of a motion of the vehicle with respect to the straight line based on a bank angle of the road section;
determine a torque condition variable indicative of the motion of the vehicle with respect to the straight line based on a torque applied to a steering wheel of the vehicle;
determine a straight-line condition for the vehicle when at least one of the control condition variable, the bank angle condition variable and the torque condition variable indicates that the vehicle is moving in the straight line; and
calibrate the sensor when the vehicle is in the straight-line condition.

17. The vehicle of claim 16, wherein the processor is further configured to determine the bank angle condition variable based on at least one of: (i) map server data; (ii) a vehicle dynamics; and (iii) Global Positioning Satellite (GPS) data.

18. The vehicle of claim 16, wherein the processor is further configured to determine a pending driving straight condition variable based on at least one of: (i) a heading condition variable based on Global Positioning Satellite (GPS) heading data; (ii) a derived heading condition variable based on a latitude and a longitude of the vehicle obtained from GPS; (iii) a wheel velocity condition variable based on differences in wheel velocities; and (iv) a road curvature condition variable.

19. The vehicle of claim 18, wherein the wheel velocity condition variable is based on a difference between at least one of: (i) a right front wheel velocity and a left front wheel velocity; (ii) a right rear wheel velocity and a left rear wheel velocity: (iii) the right front wheel velocity and the left rear wheel velocity; and (iv) the left front wheel velocity and the right rear wheel velocity.

20. The vehicle of claim 18, wherein the road curvature condition variable is based on at least one of: (i) a left-side image obtained from a left-side camera of the vehicle; (ii) a right-side image obtained from a right-side camera of the vehicle; and (iii) a meaning of a road sign in at least one of the left-side image and the right-side image.
